(19) United States
(12) Patent Application Publication
(10) Pub. No.: US 2001/0055722 A1
(43) Pub. Date: Dec. 27, 2001

(54) Black toner composition providing enhanced transfer

(75) Inventors: Donald Saul Rimai, Webster, NY (US); Matthew Chigozie Ezenyilimba, Walworth, NY (US); William Keith Goebel, Rochester, NY (US); Dinesh Tyagi, Fairport, NY (US)

Correspondence Address: Lawrence P. Kessler, NexPress Solutions LLC, Patent Department, 1447 St. Paul Street, Rochester, NY, 14653-7103, US

(73) Assignee: NexPress Solutions, LLC

(21) Appl. No.: 09/904,417

(22) Filed: Jul. 12, 2001

Related U.S. Application Data
(62) Division of application No. 09/498,119, filed on Feb. 4, 2000.

(51) Int. Cl. G03G 9/09

(52) U.S. Cl. 430/108.1; 430/111.4; 430/137.1

(57) ABSTRACT

A black toner composition comprises dried pigmented LC toner particles comprising a thermoplastic polymer and a carbon pigment having a BET value of up to about 140, and submicron particulate addendum material disposed on the dried pigmented LC toner particles. A process for forming the toner composition comprises: forming pigmented LC toner particles comprising a thermoplastic polymer and a carbon pigment having a BET value of up to about 140, drying the pigmented LC toner particles, and blending the dried pigmented LC toner particles with submicron particulate addendum material.

### CROSS-REFERENCE TO RELATED APPLICATIONS

This application is a divisional of U.S. patent application Ser. No. 09/498,119, filed Feb. 4, 2000.

### FIELD OF THE INVENTION

The present invention is directed to toner compositions for electrophotography and, more particularly, to black toner compositions that provide enhanced toner transfer from a transfer member to a receiver.

### BACKGROUND OF THE INVENTION

A dry electrographic image such as an electrophotographic image is typically produced by initially forming an electrostatic latent image on a primary imaging member. This image can be formed, for example, by first charging a photoconductive element included in a primary imaging member, then discharging selected portions of that element using optical exposure or an electronic means of exposure such as a laser scanner or an LED array. The resulting electrostatic latent image on the photoconductive element is developed by bringing it into close proximity to an appropriate developer comprising marking or toner particles, which are deposited onto the latent image to convert it into a visible image. The resulting visible image is then transferred to a receiver sheet such as paper using a variety of techniques such as applied heat or pressure, but most commonly by the application of a suitable electrostatic field to urge the toner towards the receiver. After transfer, the image is permanently fixed on the receiver, typically using heat and/or pressure to soften the toner comprising the visible image, causing it to be fused and thereby permanently affixed to the receiver. The primary imaging member from which the image has been transferred is then leaned and made ready for subsequent imaging.

Color images are generally produced by first producing electrostatic latent images corresponding to the primary color separations of the image. For example, to produce a full-color image, cyan, magenta, yellow, and black separations are produced, preferably on separate frames of the primary imaging member. A single frame can be used for all the separations, in which case it is desirable to transfer each separation image after developments to a receiver. It is possible, though less desirable, to develop all the images sequentially on the same frame of the primary imaging member and then transfer the entire image to the receiver in one pass. The individual visible separation images must be transferred in register to the receiver.

It is often desirable to first transfer a toned image from the primary imaging member to an intermediate transfer member by the application of a suitable electric field. Images corresponding to the toned separations can be transferred, in register, to the intermediate transfer member and subsequently transferred to the receiver by application of a second electric field to urge the toned image from the intermediate transfer member to the receiver. Alternatively, the separation images can be transferred to the intermediate transfer member and then to the receiver, with the final registration occurring on the receiver. It should be noted that, reference to four colors is made in this discussion, more or fewer colors can be straightforwardly employed. The intermediate transfer member can comprise either a drum or a web and is preferably a compliant member, as is known in the art.

As already noted, the developer comprises marking or toner particles and preferably further comprises magnetic carrier particles in a so-called two-component developer, which is generally used in a magnetic brush, known in the art. In addition, the developer can include a third component comprising particulate addenda of submicron size, for example, silica, strontium titanate, barium titanate, titanium dioxide, various polymeric particles. These addenda are typically employed to control flow, enhance transfer, and control toner charge-to-mass characteristics. The developer may also comprise other materials such as charge agents.

It is important in electrophotographic development that the toner be electrically insulating. If it is not, the absolute value of the toner charge-to-mass, referred to hereafter simply as “toner charge-to-mass”, can become so low that mechanical agitation at the development station causes the toner to separate from the developer as a dust cloud, whose deposition on the primary imaging member results in unacceptable background in the final print. In addition, the airborne toner can be deposited on other surfaces such as those of the charging device, causing contamination that adversely affects the operation of the device, resulting in lost productivity and possibly requiring an expensive service call. Such problems are particularly troublesome at magnetic core development stations, especially those in which the core rotates, referred to as the SPD process, as described in Miskinis, IS&T Sixth International Congress on Advances in Non-Impact Printing, pp. 101-110. In such stations the magnetic core imparts significant agitation to the developer, thereby inducing significant dusting if the toner has too low a charge-to-mass.

The electrostatic transfer field for transferring the toned image to either the intermediate transfer member or the receiver can be accomplished in a number of ways known in the art, most frequently through the use of either a biased roller or a corona charger. A compliant intermediate transfer member can comprise the biased roller.

Although many receivers are known in the art, including transparency stock, cloth, and metal, paper is most commonly employed as the receiver. It is generally desirable that the transfer member, intermediate transfer member, and receiver have finite resistivities in order to establish the electrostatic transfer field. Furthermore, to ensure successful toner transfer, it is necessary that the toner particles bear an electric charge that is maintained throughout the transfer process. The electrostatic force urging the toner to transfer is the mathematical product of the charge on the toner and the applied electrostatic transfer field. If the toner loses its charge, or worse, if the sign of the charge changes during the transfer process, the toner would fail to transfer.

To prevent toner from discharging, the toner must be electrically insulating, with no electrically conducting components residing at the toner particle surface, where they could contact a second electrically conductive material such as paper, fabrics, metals, etc., during the transfer process. Were this to occur, charge could travel from a conducting component at the toner surface to the second conductive material under the influence of the electric field, causing the toner to reach an equipotential state with the second material, for example, a paper receiver. Under normal relative humidity conditions, paper is fairly electrically conductive. Charge would bleed from the toner to the paper, ultimately reaching the potential of the paper. Under this circumstance, the toner would be more attracted to the transfer member than the paper receiver, thereby preventing toner transfer. The toner could also lose charge in the development station by contacting carrier, other toner particles, or metallic components of the station.

Although the polymer binder included in the toner is insulating, electrically conducting agents, for example, electrically conducting pigments such as carbon are frequently incorporated into toner particles. Carbon is a preferred pigment for black toner because it is inexpensive and non-fading, but it is also electrically conductive. This conductivity of carbon generally does not present a problem if it is dispersed into a molten polymer binder to form a solid block of pigment-binder material, from which toner particles are produced by grinding and classifying. However grinding and classification techniques are disadvantageous for the production of toner particles of uniform size distribution and small diameter, i.e., mean volume weighted diameter less than 8 μm, as measured by devices such as a Coulter Multisizer, available from Coulter Electronics, Inc. For the production of such toner particles, colloidally stabilized limited coalescence (LC) suspension processes that entail dissolving either the polymer comprising the toner binder (“polymer suspension”) or the monomers that combine to form the polymer binder (“suspension polymerization”) in an organic solvent, and dispersing appropriate additional toner components such as the pigment particles in the solution, are useful. Colloidally stabilized suspension processes useful in the practice of the present invention are described in, for example, U.S. Pat. Nos. 4,833,060, 4,835,084, 4,965,131, and 5,133,992, the disclosures of which are incorporated herein by reference.

In colloidally stabilized suspension processes, which are carried out in a mixture of water and a hydrophobic organic phase, fine hydrophobic particles such as silica, titania, various latices, etc., prevent the formation and separation of macroscopic hydrophilic and hydrophobic phases. If desired, the particles that limit coalescence can be removed by such processes as dissolution in strong alkalis, etc. Throughout this disclosure, toners formed by dispersing pigments and hydrophobic solutions of polymers or monomers in water will be referred to as LC toners. While LC toners formed in this manner generally charge well, black LC toners, defined as LC toners that include carbon as the pigment, do not. Specifically, black LC toners tend to display an undesirably low charge-to-mass. Consequently, the force applied to the toner to urge it from the transfer member may be insufficient to overcome those forces holding the toner to the member. Moreover, although it might be expected that transfer would improve with increasing transfer voltage until air breakdown occurs, transfer that appears satisfactory at low voltages may unexpectedly achieve an undesirably low maximum prior to decreasing with increasing transfer voltage.

Thus there is a continuing need for toner compositions, black toners in particular, that provide high transfer efficiency, especially from the intermediate transfer member of an electrophotographic apparatus to a paper receiver. This need is met by the toner composition and process of the present invention.

### SUMMARY OF THE INVENTION

The present invention is directed to a black toner composition that comprises dried pigmented LC toner particles comprising a thermoplastic polymer and a carbon pigment having a BET value of up to about 140, and submicron particulate addendum material disposed on the surface of the pigmented LC toner particles.

Further in accordance with the present invention is a process for forming a black toner composition that comprises: forming pigmented LC toner particles comprising a thermoplastic polymer and a carbon pigment having a BET value of up to about 140, drying the pigmented LC toner particles, and blending the dried pigmented LC toner particles with submicron particulate addendum material.

### DETAILED DESCRIPTION OF THE INVENTION

A standard technique for measuring the surface area of particles, based on measuring the amount of nitrogen absorbed by the particles, is described in Brunauer, Emmett, and Teller, J. Amer. Chem. Soc., 1938, Vol. 52, p 309, and also in A. W. Adamson, Physical Chemistry of Surfaces, second edition, 1967, Interscience, New York, pp 584-589, and J. K. Beddow, Particulate Science and Technology, 1980, Chemical Publishing, New York, pp 45-47, the disclosures of which are incorporated herein by reference. The amount of absorbed nitrogen is expressed as a BET number, the higher the value, the greater the amount of nitrogen absorption. BET values can be calculated as described in P. Chenebault and A. Schrenkamper, “The Measurement of Small Surface Areas by the B.E.T. Adsorption Method” in J. Phys. Chem., 1965, Vol. 69, No. 7, July 1965, pp 2300-2305, the disclosure of which is incorporated herein by reference. The specific methods and use of nitrogen as the adsorbate are discussed by S. J. Gregg and K. S. W. Sing in Adsorption, Surface Area, and Porosity, 1982, Academic Press, New York, chapter 2, pp 41-110, the disclosures of which are incorporated herein by reference. The BET values referred to throughout this disclosure and in the claims correspond to the amount of nitrogen absorption by each of the described carbon pigments.

High transfer efficiencies, particularly from the intermediate transfer member of an electrophotographic apparatus to a paper receiver are obtained with black toner compositions of the present invention, which include dried pigmented LC toner particles comprising a thermoplastic polymer and carbon having a BET value of up to about 140, preferably up to about 90, more preferably, up to about 50. The composition further includes submicron particulate addendum material disposed on the surface of the dried pigmented LC toner particles.

Although this invention is not to be restricted by any particular scientific hypothesis, the following suggestion as to the effect of the surface area of the carbon particles, as represented by measured BET values, is offered. In a limited coalescence process for producing a LC toner, a polymer binder or polymer-forming monomer is dissolved in an organic solvent, other ingredients such as, for example, carbon black pigment particles are added, and the resulting slurry is dispersed in water. A particulate hydrophilic dispersing agent such as silica, latex, strontium titanate, titania, etc., typically having a diameter in the range of tens of nanometers, is added to the slurry. The dispersing agent particles tend to flocculate at the organic-aqueous interface, thereby limiting the coalescence of the organic phase. Hydrophilic carbon particles that are present as the LC toner pigment also flocculate at the water-organic solvent interface to minimize the Gibbs free energy of the system. However, unlike the dispersing agent particles used to limit coalescence, carbon is electrically conducting. If the carbon at a toner particle surface comes into contact with an electrically conducting material, an exchange of charge is likely, particularly, when, in addition to the charge on the particle, there is an applied electrostatic field that is supposed to urge the toner particles towards the conducting member. This problem is recognized in U.S. Pat. Nos. 5,118,588 and 5,262,269, which propose the use of a surface modifying agent to cause the pigment to be dispersed internally within the toner particle. Regal 300 carbon from Cabot, whose BET value is 80, is the pigment carbon employed in these patents, the disclosures of which are incorporated herein by reference.

The amount of the free energy reduction resulting from flocculation of the carbon particles depends on the surface area of the affected particles. Accordingly, the measured BET value of the particular added carbon, which corresponds to its surface area, is a significant parameter. The lower the BET value of the carbon particles, the less likely they will flocculate at the organic-aqueous interface and the more likely they will be surrounded by an electrically insulating polymer layer that prevents undesired electrical discharge of the toner particles resulting from contact with a electrically conducting material.

In the black toner composition of the present invention, the pigmented LC toner particles have a mean volume-average diameter preferably of less than about 8 μm, more preferably, from about 3 μm to about 7 μm, and include, preferably, about 1 wt. % to about 20 wt. %, more preferably, about 3 wt. % to about 10 wt. %, most preferably, about 5 wt. % to about 8 wt. % of carbon pigment. The thermoplastic polymer included in the pigmented particles is selected from the group consisting of polyolefins, styrene resins, acrylic resins, polyesters, polyurethanes, polyamides, polycarbonates, and mixtures thereof. Of these, polyesters are preferred.

The toner composition of the present invention also comprises, preferably, about 0.1 wt. % to about 10 wt. %, more preferably, about 0.5 wt. % to about 5 wt. %, most preferably, about 1 wt. % to about 2.5 wt. %, of particulate addendum material on the surface of the LC toner particles. The particulate addendum material has a volume-average diameter of, preferably, about 10 nm and about 0.3 μm, more preferably, about 20 nm to about 100 nm. Suitable particulate addendum materials include silica, titania, barium titanate, strontium titanate, colloidal polymer latices, and mixtures thereof. Of these, silica is preferred.

In an electrophotographic apparatus, the applied electrostatic field associated with transfer can be applied by one of several means. The preferred means is to contact the receiver sheet with a semiconducting roller. The resistivity of the roller is typically between 10⁷ and 10¹² Ω•cm, preferably between 10⁸ and 10¹⁰ Ω•cm. This roller generally comprises an elastomeric member such as polyurethane on a conducting core such as aluminum. A bias of between 1,000 and 3,000 volts, preferably between 1,000 and 2,000 volts, is applied to the core. Alternatively, a roller comprising an elastomeric layer with a lower resistivity can be used. In this case, the resistivity would be between 10⁵ and 10⁷ Ω•cm, and the voltages applied to the conducting core would be correspondingly lower, typically between 500 and 1,000 volts. Alternatively, charge can be sprayed directly onto the back of the receiver by a suitable device such as a corona charger.

Although the electrostatic latent image can be formed by any of a number of electrographic techniques, it is preferred that the image be formed electrophotographically, using a primary imaging member that comprises a photoconductor. The photoconductor is initially charged to the desired potential using suitable, known charging devices such as a corona or roller charger, and the electrostatic latent image is formed by exposing portions of the charged photoconductor to light. Exposure can be accomplished using either optical or electronic means such as a laser scanner or LED array.

The electrostatic latent image is made into a visible image by bringing the electrostatic latent image into proximity with a developer comprising black toner particles of the present invention. The developer can be an insulating single-component developer or, preferably, a two-component developer comprising the toner particles and magnetic carrier, preferably ferrite, particles. Although any suitable means for applying toner to the electrostatic latent image can be used, it is preferred to use a magnetic development brush, more preferably, a small particle development( SPD) development brush.

The developed image produced with a black toner of the present invention can be transferred directly from the primary imaging member to the receiver or, preferably, to an intermediate transfer member, preferably a compliant intermediate transfer member upon application of a suitable electrostatic field, as is known in the art. Application of the electrostatic field can be accomplished by applying a suitable potential sufficiently large in magnitude to overcome the attraction of the field attracting the toner to the receiver. Alternatively, the potential on the intermediate can be decreased, or preferably, the conductive layer of the intermediate can be grounded and a suitable urging potential applied to the receiver using known means such as a biased roller or plate, a corona charger, etc. As a further alternative, the sign of the potential to the intermediate transfer member can be reversed and the receiver grounded prior to transfer of the developed image intermediate transfer member to the receiver. The image on the receiver is then fused, and the primary and intermediate transfer members are cleaned and made ready for subsequent image formation.

### EXAMPLES

In the following illustrative examples of the present invention, the toner particles are prepared by dissolving Kao C polymer, a polyester binder polymer available from Kao Corporation, in ethyl acetate and adding to the resulting solution commercially available carbon particles having different BET numbers, the values of which were provided by the the manufacturers of the particles. The organic phase is then mixed with an aqueous phase comprising pH4 buffer containing Nalco® 1060, poly(adipic acid-co-methylaminoethanol), and silica dispersing agent, as described in the previously mentioned U.S. Pat. No. 4,833,060. The mixture is subjected to very high shear using a Polytron shear machine, available from Brinkman, followed by further shearing treatment with a microfluidizer. The solvent is removed from the particles so formed by stirring overnight at room temperature in an open container. The particles are washed with potassium hydroxide solution and then with water to remove the silica dispersing agent, and dried. The dried toner particles are then dry blended with R972 silica, available from DeGussa, the amount of added silica corresponding to a coverage of approximately 1.5% by weight for a 6-μm diameter toner particle. In this manner, the surface concentration of the silica is held approximately constant. The developer is then prepared by blending the toner with a ferrite carrier to produce a developer with a 6% by weight toner concentration.

Images are made by charging a commercially available organic photoconducting primary imaging member, followed by optical exposure through a transparent, neutral density step tablet. The resulting electrostatic latent image is then developed by bringing the developer, contained in an SPD development station, into close proximity to the photoconductor. The developed image is transferred by applying voltage to the conductive core of a compliant intermediate transfer member. Transfer of the image from the intermediate member to a paper receiver attached to a grounded metal plate is carried out by applying a suitable potential to the core of the compliant intermediate transfer member to urge the toned image towards the paper receiver.

Measurements of transfer efficiency from the intermediate transfer member to a paper receiver are made using a transmission densitometer. After zeroing out the density of the untoned paper, the density of the image on the paper receiver is determined. Residual untransferred toner is removed from the intermediate transfer member using clear tape, and its transmission density is measured through the tape after zeroing out the density of the tape. The transfer efficiencies of toner from the intermediate transfer member to the paper receiver, averaged over initial densities of between 0.1 and 1.0 on the primary imaging member, are determined as a function of transfer voltage. Data corresponding to optimal transfer efficiency between the intermediate transfer member and the paper, as well as the voltage at which that transfer occurred for the various carbons, are listed for the examples included in TABLE 1 below. It should be noted that the transfer efficiencies of toner from the primary imaging member to the intermediate transfer member are very high for all the carbons studied.

TABLE I

| | | | Wt. % | Wt. % surface | Toner | |
|---|---|---|---|---|---|---|
| | | BET | Carbon | particles | diameter | Transfer Efficiency |
| Example | Carbon* | Value | in toner | on toner | (μm) | @ applied voltage |
| 1 | Regal 330 | 89 | 6 | 1.94 | 4.8 | 69% @ 1000 V |
| 2 | Black Pearls | 88 | 6 | 1.17 | 6.2 | 85% @ 1500 V |
| | 6100 | | | | | |
| 3 | Mogul L | 138 | 6 | 1.54 | 5.4 | 75% @ 1000 V |
| 4 | Monarch | 343 | 6 | 1.54 | 5.4 | 50% @ 1000 V |
| (Comp.) | 1000 | | | | | |
| 5 | Raven 5750 | 575 | 6 | 1.54 | 5.4 | 29% @ 1000 V |
| (Comp.) | | | | | | |
| 6 | Sterling R | 25 | 6 | 1.06 | 6.5 | 89% @ 1500 V |
| 7 | Black Pearls | 42 | 8 | 2.30 | 4.4 | 89% @ 1500 V |
| | 280 | | | | | |

*Raven 5750 available from Columbia Chemical Co, all other carbons available from Cabot Corp.

The toner of Example 1, containing Regal 330 carbon (BET 89) and 1.94 wt. % surface silica, has a particle diameter of only 4.8 μm, which would be expected to hamper transfer At a voltage of 1000 volts, a fair transfer efficiency to paper of 69% is achieved.

The toner of Example 2, containing Black Pearls 6100 carbon (BET 88) and 1.17 wt. % surface silica, has a particle diameter of 6.2 μm, somewhat larger than that of Example 1. At a voltage of 1500 volts, a high transfer efficiency to paper of 85% is achieved.

The toner of Example 3, containing Mogul L carbon (BET 138) and 1.54 wt. % surface silica, has a particle diameter of 5.4 μm. At a voltage of 1000 volts, a fair transfer efficiency to paper of 75% is achieved.

The toner of Comparative Example 4, containing Monarch 1000 carbon (BET 343) and 1.54 wt. % surface silica, has a particle diameter of 5.4 μm. The BET value for Monarch 1000 carbon lies outside that required by the present invention, and, at a voltage of 1000 volts, a poor transfer efficiency to paper of 50% is observed.

The toner of Comparative Example 5, containing Raven 5750 carbon (BET 575) and 1.54 wt. % surface silica, has a particle diameter of 5.4 μm. The BET value for Raven 5750 carbon lies well outside that required by the present invention, and, at a voltage of 1000 volts, a very poor transfer efficiency to paper of only 29% is observed.

The toner of Example 6, containing Sterling R carbon (BET 25) and 1.06 wt. % surface silica, has a particle diameter of 6.5 μm At a voltage of 1500 volts, a high transfer efficiency to paper of 89% is achieved.

The toner of Example 7, containing Black Pearls 280 carbon (BET 42) and 2.30 wt. % surface silica, has a very small particle diameter, only 4.4 μm, Nonetheless at a voltage of 1500 volts, this toner displays a very high transfer efficiency to paper, 89%

The foregoing results demonstrate that reasonably efficient transfer from an intermediate transfer member to a receiver can be obtained with toner particles containing surface particulates, preferably silica, and carbon pigments having BET values as high as about 140. More preferably, the BET value of the carbon is below about 90; most preferably it is below about 50.

The invention has been described in detail with particular reference to certain preferred embodiments thereof, but it is to be understood that variations and modifications can be effected within the spirit and scope of the invention, which is defined by the following claims.

What is claimed:

1. A black toner composition comprising:
dried pigmented LC toner particles comprising a thermoplastic polymer and a carbon pigment having a BET value of up to about 140; and
submicron particulate addendum material disposed on said dried pigmented LC toner particles.

2. The toner composition of claim 1 comprising a dry blend of said pigmented LC toner particles and said submicron particulate addendum material.

3. The toner composition of claim 1 wherein said carbon pigment has a BET value of up to about 90.

4. The toner composition of claim 3 wherein said carbon pigment has a BET value of up to about 50.

5. The toner composition of claim 1 wherein said pigmented particles comprise about 1 wt. % to about 20 wt. % carbon pigment.

6. The toner composition of claim 5 wherein said pigmented particles comprise about 3 wt. % to about 10 wt. % carbon pigment.

7. The toner composition of claim 6 wherein said pigmented particles comprise about 5 wt. % to about 8 wt. % carbon pigment.

8. The toner composition of claim 1 wherein said pigmented particles have a mean volume-average diameter of less than about 8 μm.

9. The toner composition of claim 8 wherein said pigmented particles have a mean volume-average diameter of about 3 μm to about 7 μm.

10. The toner composition of claim 1 comprising about 0.1 wt. % to about 10 wt. % of said submicron particulate material.

11. The toner composition of claim 10 comprising about 0.5 wt. % to about 5 wt. % of said submicron particulate material.

12. The toner composition of claim 11 comprising about 1 wt. % to about 2.5 wt. % of said submicron particulate material.

13. The toner composition of claim 1 wherein said submicron particulate material has a volume-average diameter of about 10 nm to about 0.3 μm.

14. The toner composition of claim 13 wherein said particulate material has a volume-average diameter of about 20 nm to about 100 nm.

15. The toner composition of claim 1 wherein said thermoplastic polymer is selected from the group consisting of polyolefins, styrene resins, acrylic resins, polyesters, polyurethanes, polyamides, polycarbonates, and mixtures thereof.

16. The toner composition of claim 15 wherein said thermoplastic polymer comprises a polyester.

17. The toner composition of claim 1 wherein said particulate material is selected from the group consisting of silica, titania, barium titanate, strontium titanate, colloidal polymer latices, and mixtures thereof.

18. The toner composition of claim 16 wherein said particulate material comprises silica.

19. A process for forming a black toner composition comprising:
forming pigmented LC toner particles comprising a thermoplastic polymer and a carbon pigment having a BET value of up to about 140;
drying said pigmented LC toner particles; and
blending said dried pigmented LC toner particles with submicron particulate addendum material.

20. The process of claim 19 wherein said pigmented LC toner particles are formed by limited coalescence.

21. The process of claim 19 wherein said carbon pigment has a BET value of up to about 90.

22. The process of claim 21 wherein said carbon pigment has a BET value of up to about 50.

23. The process of claim 19 wherein said pigmented particles comprise about 1 wt. % to about 20 wt. % carbon pigment.

24. The process of claim 19 wherein said pigmented particles have a mean volume-average diameter of less than about 8 μm.

25. The process of claim 19 wherein said toner composition comprises about 0.1 wt. % to about 10 wt. % of said submicron particulate addendum material.

26. The process of claim 19 wherein said submicron particulate addendum material has a volume-average diameter of about 10 nm to about 0.3 μm.

27. The process of claim 19 wherein said thermoplastic polymer is selected from the group consisting of polyolefins, styrene resins, acrylic resins, polyesters, polyurethanes, polyamides, polycarbonates, and mixtures thereof.

28. The process of claim 27 wherein said thermoplastic polymer comprises a polyester.

29. The process of claim 19 wherein said particulate addendum material is selected from the group consisting of silica, titania, barium titanate, strontium titanate, colloidal polymer latices, and mixtures thereof.

30. The process of claim 29 wherein said particulate addendum material comprises silica.
